(19) United States
(12) Patent Application Publication
(10) Pub. No.: US 2025/0246836 A1
(43) Pub. Date: Jul. 31, 2025

(54) MODULAR ELECTRICAL TERMINAL SET WITH INTERCHANGEABLE CONNECTION TERMINALS

(71) Applicant: Aptiv Technologies AG, Schaffhausen (CH)

(72) Inventors: Laurent MORIN, Rambouillet (FR); Sebastian ANUP, Pathanamthitta (IN); Rama Krishna MANNE, Bapatla (IN); Suresh NANDA-KUMAR, Chennai (IN)

(21) Appl. No.: 19/039,850

(22) Filed: Jan. 29, 2025

(30) Foreign Application Priority Data
Jan. 31, 2024 (IN) 202441006279

(51) Int. Cl. H01R 13/03; H01R 4/18

(52) U.S. Cl. CPC H01R 13/03; H01R 4/182; H01R 4/183

(57) ABSTRACT

A modular electrical terminal set includes a base element equipped with connection means, a 90° terminal, and a 180° terminal. The 90° terminal is provided with fixation means that enable its attachment to the connection means of the base element, thereby forming a 90° connection terminal. Similarly, the 180° terminal is equipped with fixation means for attachment to the connection means of the base element, resulting in a 180° connection terminal. This configuration allows for versatile electrical connections by providing options for both 90° and 180° terminal orientations, enhancing adaptability in various electrical setups.

### CROSS-REFERENCE TO RELATED APPLICATION

This application claims the benefit of and priority to Indian Patent Application number 202441006279 filed on Jan. 31, 2024, the contents of which are hereby incorporated by reference.

### TECHNICAL FIELD

The present disclosure relates to a modular electrical terminal set for signal and power transmission, and in particular for electrical high power connections.

### BACKGROUND

Traditional electrical terminal sets have often relied on fixed configurations, which limit their adaptability to various installation requirements. These conventional systems typically involve a single-piece design where the terminals are permanently attached to the base element. This design approach can lead to inefficiencies, as it necessitates the use of multiple distinct terminal sets to accommodate different connection angles, such as 90° or 180°, thereby increasing inventory requirements and complicating installation processes.

In an attempt to address these limitations, some systems have introduced adjustable or rotatable terminals. These designs allow for some degree of flexibility in the orientation of the terminals relative to the base element. However, such systems often involve complex mechanical components or require additional tools for adjustment, which can increase the cost and complexity of the installation. Furthermore, the mechanical stability of these adjustable terminals can be compromised, leading to potential reliability issues over time.

Another approach has been the use of modular terminal blocks, where individual terminal units can be added or removed from a base rail. While this method provides some modularity, it typically does not offer the specific angular configurations needed for certain applications without additional components or adapters. This can result in a cumbersome setup process and may not provide the desired level of customization for specific electrical installations.

Existing terminal designs are typically machined and are relatively expensive. The machining of the terminals results in long cycle times and high material waste. Further, in the case of 180° connection terminals, the terminals must often be fully silver plated to achieve satisfactorily transmission efficiency. 90° terminals regularly require a completely different manufacturing process, and so 180° terminals and 90° terminals cannot be produced on the same manufacturing line.

Accordingly, none of these approaches have provided a comprehensive solution that combines the features described in this disclosure.

### SUMMARY

Accordingly, it is an object of the present disclosure to present an improved terminal concept, which allows an improved assembly of 180° and 90° terminals. It is a further object of the present disclosure to provide such a concept which minimizes the cycle times in production and the material waste. Further, it is an object of the present disclosure to achieve all the above advantages with an inexpensive product, whereby at least some of the electrically conductive components can preferably be made from sheet metal.

A modular electrical terminal set is hereby provided, allowing 90° connection or 180° connection. The set includes a base element having connection means; a 90° terminal with fixation means to attach the 90° terminal with the connection means of the base element to form a 90° connection terminal, and a 180° terminal with fixation means to attach the 180° terminal with the connection means of the base element to form a 180° connection terminal.

The base element is for both connection types the same, which facilitates the manufacturing process, since only one type of base element is required, that is suitable for both kind of terminals. The base element may be provided with axial and side screw connections, for example in the form of internal threaded boreholes. The 90° terminal allows, as the name implies, a 90° connection, whereas the 180° terminal allows a 180° connection. The base element is a provided with connection means that allow a fixation of either a 90° terminal or a 180° terminal. This may be realized by two different connection elements, where one is dedicated for the 90° terminal and the other is dedicated for the 180° terminal. It may also be realized by a common connection element, which allows the connection of both terminal types.

The fixation means of the terminals can thus be different from each other, so that each terminal can only be connected to its dedicated connection element (connection means), of the base element. This can be advantageous if for example it needs to be secured that the respective terminals are fixed to the base element in a certain orientation. Alternatively, it is also possible to provide both terminals with the same fixation means, which then may allow a connection with the same connection means of the base element. This has the advantage, that the manufacturing process of the modular set is even further facilitated, as the same tools can be used to produce the fixation means of both type of terminals and only one tool is required for example to produce the connection means of the base element. In any case, the connection as well as the fixation means may be provided in the form of screw type connections. The connection means of the base element may for example be a threaded borehole, and the fixation means of the terminals may include a screw or a threaded bolt or similar. Naturally, an opposite arrangement is also possible.

Preferably, the base element includes additional connection means enabling a connection of the base element with a power source. The base element may be provided with additional means that allow connection to, for example a power cable or a battery or similar. Thereby, the base element may be connected to a power source and the terminals allow a connection to an electrical load. However, the terminals may also be used to connect for example to a cable which transfers energy or signals to an electrical component.

In another preferred example, the 90° terminal includes two parts. By using two or more parts for the 90° terminal, a larger degree of freedom is associated with the manufacturing process. One may for example use a cheaper material for one part, which may not need a high level of sophistication, and a more expensive material, or a more expensive manufacturing process, for another part, which may require a higher degree of quality or sophistication.

In this context, preferably, the 90° connector includes a stamped extension part and a terminal part attached to the stamped extension part. The extension part serves as connection to the base element and the terminal part is the actual contact terminal, which establishes a signal or power connection with another component. Since the connection to the base element does not require a complicated part, it may be produced from stamped sheet metal, thereby saving manufacturing costs.

Preferably, in this context, the terminal part extends in a 90° angle from the stamped extension part. The stamped extension part may for example in its simplest form be just a length off sheet metal and the actual terminal part may be attached thereto and extend perpendicular therefrom. This is a simple but reliable solution, which is very suitable for a mass production process.

Preferably, in this context, the terminal is made from forged metal and/or the stamped extension part is made from sheet metal. For many applications, the terminal part itself has to fulfill relatively high quality requirements as it is crucial for a safe and efficient connection to the respective electrical component that is to be connected by the terminal. Therefore, it is in many instances advantageous to produce the terminal from forged metal, although this is a relatively expensive manufacturing process. On the other hand, the extension part typically does not need to fulfill such high quality requirements, so that it can be produced from a relatively less expensive sheet metal, which is stamped and bend as required.

Preferably, the stamped part is a bus bar. As the skilled person knows, a bus bar is typically a metallic strip or bar in electric power distribution applications.

Generally preferred, the 180° terminal is made from forged metal, and is preferably one integral part. A 180° terminal is typically simpler to produce compared to a 90° terminal. Thus, it is advantageous to produce the 180° terminal in a single part. As the design is usually not too complex, a forging process is suitable and allows an inexpensive and efficient mass production of the terminal.

Generally preferred, the base element essentially has the form of a cube. A cube is a geometric form that is simple to produce and to machine. The cube may for example be provided with various kinds of connection means, as internally threaded bore holes, which can easily be machined into the cube.

Preferably, the base element is made by cold forging and/or machining from metal, preferably from a single piece of metal. The use of a forged base element results in a very robust construction that can easily be worked on, for example, being provided with the required connection means. It may be formed from a single piece of metal, which is cold forged or machined. This leads to a robust design that is well suitable for mass production.

Preferably, the base element includes holes with internal threading for connecting the base element with other components, such as power lines or the terminals. As the base element is for example advantageously made from a simple cube of metal, it is relatively easy to provide it with the required connection means, as for example screw type connection means. By machining the base element and providing it with the boreholes with internal threading, simple yet reliable connecting opportunities may be created. For example, the terminals may be provided with a threaded bolt on one end and simply screwed into the base element.

Preferably, the terminals are plated with silver. A plating with silver improves the conductivity of the terminals. It should be understood that the plating may not necessarily be provided on all surfaces of the terminals, but that the plating may only be applied on those parts of the terminals, where an improved conductivity is most helpful.

Preferably, the base element is plated with nickel, tin or an alloy of nickel and tin. A plating improves the conductivity of the base element. It should be understood that the plating may not necessarily be provided on all surfaces of the base element, but that the plating may only be applied on those parts of the element, where an improved conductivity is most helpful.

Generally preferred, the connection means allow a crimping connection between base element and terminals. The base element may for example be provided with a protrusion and a terminal may be provided with a reception that is configured to receive the protrusion therein. By crimping the material of the terminal around the reception, it is possible to crimp the terminal onto the protrusion and thus onto the base element. It is also possible to provide the base element with, for example, a cylindrical protrusion, which is hollow and open on its end. A terminal may for example be provided with a protrusion, which is configured to fit into the opening of the cylindrical protrusion. After insertion of the terminal's protrusion into the opening of the cylindrical protrusion, the material of the cylindrical protrusion may be crimped, thereby establishing a crimp connection. A press-fit engagement is also a suitable alternative.

Generally preferred, the terminals are male terminals, preferably male power terminals.

Further preferred, the terminals are round or flat and have preferably an essentially round cylindrical shape. A round shape is a simple geometric form that can easily be produced in mass production. The cylindrical shape further allows a facilitated connection to other electrical components or terminals or similar.

Preferably, the electrical terminal set is configured for high voltage applications. While it is of course also possible to use the electrical terminal set for signal transmission, it offers particular advantages in power transmission applications, and in particular in high voltage power transmission applications. The concept allows a very robust design of the various components, which may be made from forged integral parts of metal, which are well suitable for the handling of high currents or voltages.

### BRIEF DESCRIPTION OF THE DRAWINGS

FIG. 1A illustrates a perspective view of a 90° terminal according to the prior art.

FIG. 1B illustrates a perspective view of a 180° terminal according to the prior art.

FIGS. 2A to 2D illustrate perspective views of a modular electrical terminal set according to some embodiments.

FIGS. 3A and 3B illustrate perspective views of a base element and a 180° terminal according to some embodiments.

FIGS. 4A and 4B illustrate perspective views of a base element and a 180° terminal according to some embodiments.

FIG. 5 illustrates a perspective view of a base element and a 180° terminal according to some embodiments.

### DETAILED DESCRIPTION

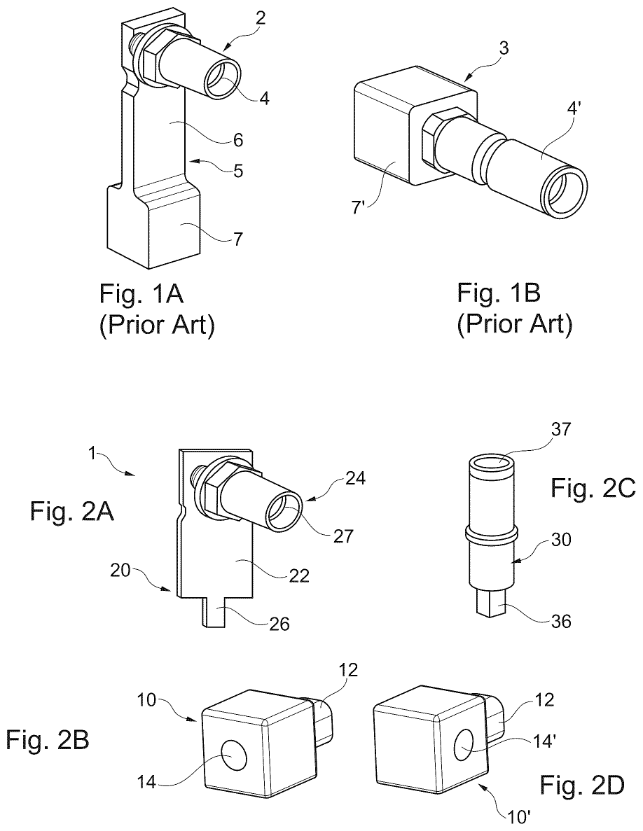

FIG. 1A shows a 90° terminal 2 and FIG. 1B shows a 180° terminal 3 according to the prior art. The 90° terminal 2 is composed of essentially two parts: a terminal part 4 and a connecting part 5. The connecting part 5 has an essentially rectangular extension part 6 and a cube shaped base element 7. The base element 7 serves as attachment or connecting point to various other electrical components or a power supply. The terminal 4 is for example screwed onto the extension part 6.

The 180° terminal is made from a single piece of metal. It likewise includes a terminal part 4′ and a base element 7′. As one can take from FIGS. 1A and 1B, the terminals have no common parts and are designed and manufactured completely independent from each other. This increases the number of tools necessary for producing the two terminals and also the manufacturing time.

FIGS. 2A to 2D show a modular electrical terminal set 1 in accordance with some embodiments. The set includes a cube shaped base element 10 having a connection means 12 in the form of a cylindrical protrusion. It includes additional connection means 14 in the form of a hole with an inner thread. In FIG. 2D, an alternative design for base element 10′ is shown. It differs from the base element 10 in FIG. 2B by the arrangement of the connection means 14′. While with base element 10, the connection means 14 is opposite the connection means 12, the connection means 14′ is arranged perpendicular to the connections 12. The connection means 12 may serve to fix electrical terminals onto the base elements.

Reference numeral 20 denotes a 90° terminal. The 90° terminal 20 is composed of two parts: a stamped extension part 22 and a terminal part 24, which is attached to the stamped extension part 22. This stamped extension part 22 further includes a fixation means 26 in form of a tongue like protrusion. The fixation means 26 may for example be inserted into a slot in base element 10 (not shown). As one can take see in FIG. 2A, the terminal part 24 extends in a 90° angle from the stamped extension part 22. The terminal part 24 may be made from a forged metal and the stamped extension part 22 may be made from sheet metal, which is stamped into the configuration shown in FIG. 2A. The stamped extension part 22 may also be described as a bus bar and is preferably made from copper. The terminal part 24 may for example be screwed onto the extension part 22. It further includes an opening 27, which is configured to receive a male terminal therein. The terminal part 24 is round and has essentially a round cylindrical shape. It may however have any other suitable configuration.

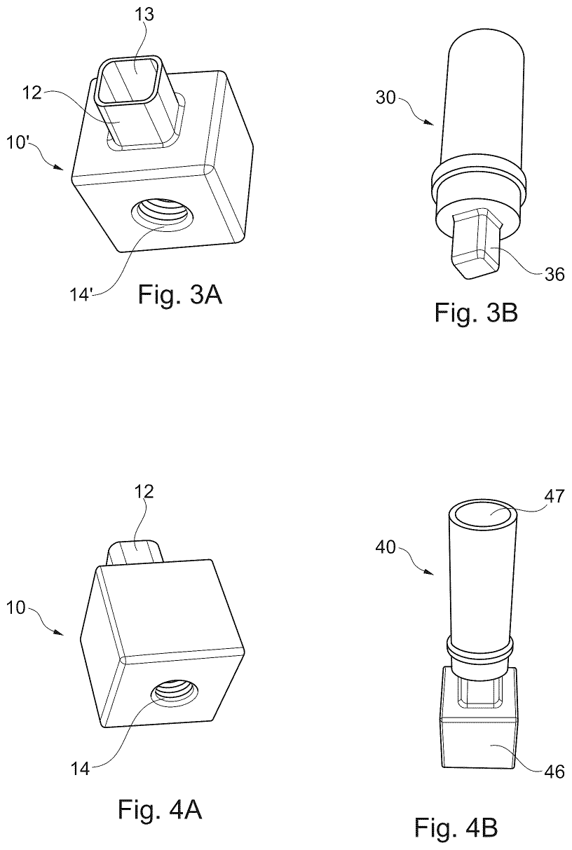

The 180° terminal 30 may be made from a single piece of forged metal. It includes an opening 37 that may be configured to receive a male terminal therein. On the opposite end, a fixation means 36 in form of a rectangular cylindrical protrusion is provided. The fixation means 36 may for example be inserted into a correspondingly shaped opening in connection means 12 of base element 10. This is better shown in FIG. 3 which will be described in the following.

FIG. 3A shows an alternative view of the base element 10′ of FIG. 2D. In this view, one can see that the hole 14′ is provided with an internal thread. The connection means 12 is essentially a rectangular cylinder protruding from the surface of base element 10′. The connection means 12 includes an opening 13, which is configured to receive the fixation means 36 of terminal 30 therein. After insertion of the fixation means 36 into the opening 13, the walls off connection means 12 can be crimped onto the fixation means 36, thereby achieving a reliable fixation of terminal 30 onto base element 10′.

FIGS. 4A and 4B shows an alternative design of a 180° terminal 40. The terminal 40 likewise has essentially a round cylindrical shape with an opening 47 to receive for example a male terminal therein. The fixation means 46 is provided on the opposite end of terminal 40 and is provided in form of a hollow cube. The hollow cube is designed such that it fits onto connection means 12 of base element 10. By crimping the outer walls of the hollow cube, a reliable fixation of terminal 40 onto base element 10 can be achieved.

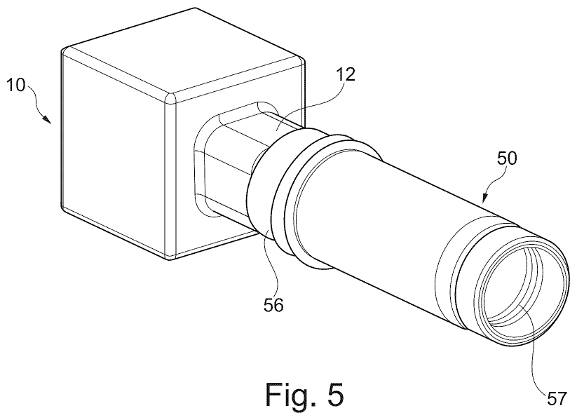

FIG. 5 illustrates a perspective of another embodiment of a base element 10 and a 180° terminal 50. The base element 10 is the same as shown in FIG. 2B. The terminal 50 includes an opening 57 on one end and a fixation means 56 on the opposite end. The fixation means 56 is essentially a round cylindrical extension of terminal 50 and configured to fit onto the rectangular cylindrical protrusion of the connections means 12 of base element 10. After inserting the connection means 12 into the opening of fixation means 56, the round wall of fixation means 56 are crimped onto the connection means 12, to achieve a reliable mechanical and electrical connection between terminal 50 and base element 10. As with all the embodiments described herein, a press-fit engagement is a suitable alternative.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects have an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

### LIST OF REFERENCE NUMBERS

1 modular electrical terminal set
2 prior art 90° terminal
3 prior art 180° terminal
4, 4′ prior art terminal part
5 prior art connecting part
6 prior art extension part
7, 7′ prior art base element
10, 10′ base element
12 connection means
13 opening in connection means
14, 14′ additional connection means
20 90° terminal
22 stamped extension part
24 terminal part
26, 36, 46, 56 fixation means
27, 37, 47, 57 opening in terminal
30, 40, 50 180° terminal
36, 46, 56 fixation means

1. A modular electrical terminal set, comprising:
a base element comprising connection means;
a 90° terminal, comprising fixation means to attach the 90° terminal with the connection means of the base element, to form a 90° connection terminal; and
a 180° terminal, comprising fixation means to attach the 180° terminal with the connection means of the base element, to form a 180° connection terminal.

2. The modular electrical terminal set according to claim 1, wherein the base element comprises additional connection means enabling a connection of the base element with a power source.

3. The modular electrical terminal set according to claim 1, wherein the 90° terminal comprises two parts.

4. The modular electrical terminal set according to claim 3, wherein the 90° terminal comprises a stamped extension part and a terminal part attached to the stamped extension part.

5. The modular electrical terminal set according to claim 4, wherein the terminal part extends in a 90° angle from the stamped extension part.

6. The modular electrical terminal set according to claim 4, wherein the terminal is made from forged metal.

7. The modular electrical terminal set according to claim 4, wherein the stamped extension part is made from sheet metal.

8. The modular electrical terminal set according to claim 4, wherein the stamped part is a bus bar, preferably from copper.

9. The modular electrical terminal set according to claim 1, wherein the 180° terminal is made from forged metal, and is preferably one integral part.

10. The modular electrical terminal set according to claim 1, wherein the base element essentially has the form of a cube.

11. The modular electrical terminal set according to claim 1, wherein the base element is made by cold forging.

12. The modular electrical terminal set according to claim 1, wherein the base element is made by machining from a single piece of metal.

13. The modular electrical terminal set according to claim 1, wherein the base element comprises holes with internal threading for connecting the base element with other components, such as power lines or the terminals.

14. The modular electrical terminal set according to claim 1, wherein the terminals are at least partially plated with silver.

15. The modular electrical terminal set according to claim 1, wherein the base element is at least partially plated with a material selected from a list consisting of nickel, tin, and nickel-tin alloys.

16. The modular electrical terminal set according to claim 1, wherein the connection means allow a crimping connection between base element and terminals.

17. The modular electrical terminal set according to claim 1, wherein the terminals are male terminals.

18. The modular electrical terminal set according to claim 1, wherein the terminals are flat.

19. The modular electrical terminal set according to claim 1, wherein the terminals have an essentially round cylindrical shape.

20. The modular electrical terminal set according to claim 1, wherein the electrical terminal set is configured for high voltage applications.
